(19) United States
(12) Patent Application Publication
(10) Pub. No.: US 2011/0266207 A1
(43) Pub. Date: Nov. 3, 2011

(54) Synergy City: a production facility for electrical power, fresh water, and trash processing without the use of nuclear fission, coal or oil

(76) Inventor: Harold James Willard, JR., Washington, DC (US)

(21) Appl. No.: 12/929,050

(22) Filed: Dec. 27, 2010

Related U.S. Application Data
(60) Provisional application No. 61/282,964, filed on Apr. 30, 2010.

(51) Int. Cl. C02F 1/00; F01D 15/10; F03D 9/00; B09B 3/00

(52) U.S. Cl. 210/251; 405/129.2; 290/4 R

(57) ABSTRACT

This invention uses existing technology in a novel way to create a production facility, which can be known as Synergy City, to provide a solution to three problems confronting the United States, and other nations as well: the need for safe, clean, renewable sources of electrical power; the need for adequate supplies of fresh water; and the need to dispose of trash in a responsible manner. A synergistic solution to these problems is presented without the use of nuclear fission, coal or oil.

A prototype of Synergy Cities is conceived in which reside scientists, engineers, technicians and their families, and others as necessary to support a viable American city in the state in which it is located. Experience in planning, developing and operating the prototype facility is to be factored into the design and construction of succeeding cities. Such cities can become man-made oases in areas of our country which are presently largely uninhabitable and non-productive, enhancing the environment in which they are located and providing employment opportunities for large numbers of highly technical, as well as non-technical workers.

### REFERENCE TO PRIOR APPLICATION

Provisional Patent Application filed Apr. 30, 2010; application Ser. No. 61/282,964; Confirmation No. 3958.

### DESCRIPTION OF THE FIGURES

FIG. 1. Potential locations in the southwestern United States for Synergy City, a facility to produce electrical power and fresh water, and to process trash, without the use of nuclear fission, coal or oil.

FIG. 2. Characteristics of Synergy City.

FIG. 3. Schematic of steam generator electrical power system.

### REFERENCES CITED

1. “Wind Power Today”' U.S. Department of Energy, DOE/GO 102007-2424, May 2007.
2. Recent speeches by President Barack Obama and Dr. Steven Chu, Secretary of Energy, 2010.
3. “Strategic Plan”, U.S. Department of Energy, Office of Legacy Management, May 2007, DOE/LM-1458.
4. Covanta Energy Corporation, 40 Lane Road, Fairfield, N.J. 07004.
5. National Sustainable Design Expo, Apr. 24-25, 2010, Environmental Protection Agency, Washington, D.C.
6. Preliminary National Rail Plan, Federal Railroad Administration, October 2009,U.S. Dept. of Transportation, 1200 New Jersey Ave S.E., Washington, D.C. 20590.
7. “Water, Our Thirsty World”, National Geographic Society, A Special Issue, April 2010, Washington, D.C.
8. Alex Moseson.net/AAC; Drexel University.
9. “U.S. Department of Energy Solar Decathlon 2009”, Office of Energy Efficiency and Renewable Energy, National Renewable Energy Laboratory, National Mall, Washington, D.C., October 2009.
10. “Earth Day on the National Mall”' Apr. 20-25, 2010; National Aeronautics and Space Administration, Washington, D.C.

### U.S. PATENT DOCUMENTS

7,836,695 B2 November 2010 Lazzara, et al.
7,832,714 B2 November 2010 Duesel, et al
7,825,327 B2 November 2010
7,735,323 B2 June 2010
7,777,363 B2 November 2010
7,735,325 B2 June 2010
7,753,122 B2 July 2010
7,744,671 B1 June 2010
7,799,472 B2 September 2010
7,744,760 B2 June 2010

### BACKGROUND OF THE INVENTION

Three on-going problems confronting the United States, as well as other nations, are: (1) the need for safe, clean, renewable sources of electrical power; (2) the need for adequate supplies of fresh water in arid regions; and (3) the need to dispose of trash in a responsible manner. Each of these problems is formidible in its own right and, as presently being addressed, each is being solved in a less than optimum manner, and in some ways using approaches which place our nation at great risk now and for the indefinite future.

The sources currently being used to supply our Nation's electrical needs are presented in Table I (Reference 1):

TABLE I
Sources of Electrical Power in the United States (Ref. 1)

| | |
|---|---|
| Coal | 48.5 |
| Natural gas | 20.5 |
| Nuclear fission | 19.2 |
| Hydroelectric, solar, | 11.2 |
| petroleum, etc. | |
| Wind | 0.7 |
| | 100.0% |

The total electrical power requirement for the United States is estimated to be about 16.25 terawatts (16,250,000 MW).

Fears that CO₂ emissions from coal-fired plants are making a significant contribution to global warming indicate that coal may no longer play the dominant role in meeting our electrical power needs. Our oil reserves are not adequate to supply all of our nation's needs and importing foreign oil is both costly and risky. Furthermore, coal and petroleum are far too valuable for the manufacture of pharmaceuticals, textiles and other products beneficial to our society to be converted to fuels and burned in boilers and engines polluting the atmosphere. When these legacies are exhausted, will we have anything to replace them?

The extraordinary dangers associated with nuclear power plants render this source unacceptable, even though President Obama and Dr. Chu, Secretary of Energy, have stated publically the intention of our government to build 50,000 megawatts of nuclear power plants (Ref. 2), either as fifty one-thousand megawatt plants or perhaps as 150 plants one-third that size in order to reduce the initial capital costs and speed up approvals and construction using mass production techniques. We now have 104 one-thousand megawatt plants in operation.

Radioactive wastes from nuclear power plants must be stored away from humans and other creatures under full military protection for tens of thousands of years to allow the high level radioactivity to decay to a safe level. Even then the residue will be highly toxic chemically. We are currently spending hundreds of millions of dollars monitoring nuclear sites constructed during the Cold War which, although supposedly cleaned up, still pose a potential danger (Ref. 3). Recently, the State of Nevada has been severely criticized for refusing to allow high level wastes to be stored at Yucca Flats. One public official accused the senator from Nevada who supported this action as endangering the rest of our country because there is no where else to put it, the option of not producing it not even being considered. (This is equivalent to a neighbor being criticized for dog crap being spread over the neighborhood because he won't allow it to be thrown in his yard!)

We should be taking steps to phase out nuclear power in a safe and orderly manner and not continue to add to the legacy of shame we are bestowing upon our future generations and our planet. It is hoped that this invention will help meet that responsibility.

It is practically impossible to protect all nuclear power plants from terrorist attacks or from acts by individuals who may become deranged and commit acts of sabotage inside these plants. In a time of war, our Nation would be extremely vulnerable because of the presence of these facilities and because of the vulnerability of the storage pools located adjacent to these plants in which the highly radioactive fuel elements are stored temporarily to cool down thermally and radioactively before being shipped to reprocessing centers. If the planes which hit the Twin Towers during the 9-11 event had instead struck the Indian Point Nuclear Power Plant located near the West Point Military Academy, it is possible (likely?) that the radioactive debris would/have contaminated the immediate area and, either through winds or the Hudson River, have made its way to the City, rendering parts of it uninhabitable for hundreds of years and causing immediate and long-term deaths in the thousands. The genetic damage could be inestimable.

The consequences of such an act are unacceptable to our Nation; consequently the risks for such an event must be reduced to zero, or nearly so, since we are already past our ability to eliminate the risk entirely.

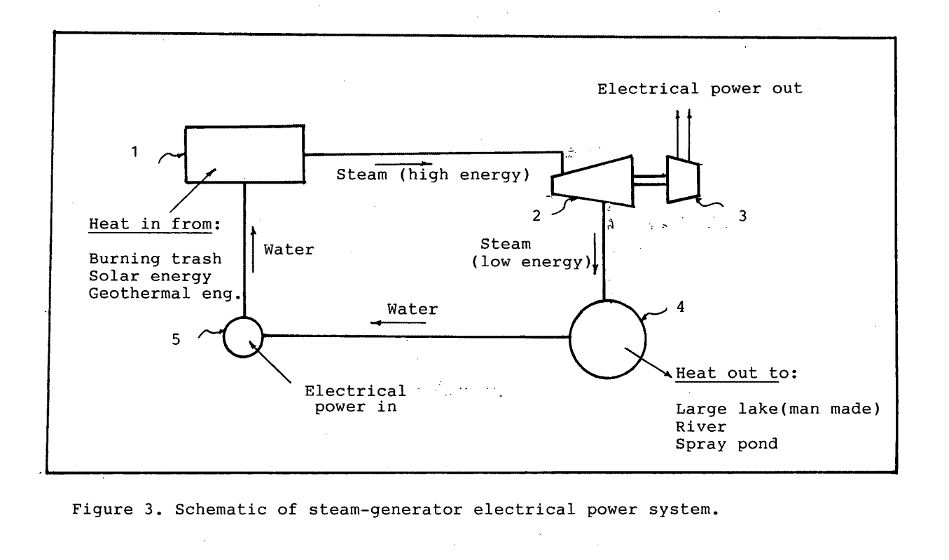

Our cities and communities create enormous amounts of trash, much of which is disposed of in landfields and dumped at sea, both undesirable solutions to the problem. Wood, rags, paper and other combustibles are sources of heat for thermal turbine-generator plants (FIG. 3). Some communities are operating such facilities and at least one major industrial corporation is providing such a service profitabally (Ref. 4).

Such refuse fuel, which can include biomass substances from which methane can be extracted (Ref. 5), can be processed in local communities for transportation via high-speed rail to Synergy Cities to be used as fuel in large turbine-generator plants. Such a rail system is already under consideration by our government (Ref. 6).

Estimates are that refuse fuel could provide as much as 80% of our Nation's electrical needs, if properly harnessed (Ref. 4). Similar estimates for solar power and geothermal sources have yielded equally optimistic projections. And it is difficult to imagine what future research might bring in this area, if a proper facility is provided to support the effort. It is a primary purpose of Synergy City to make such effort feasible, but unlike our national laboratories, such as Los Alamos, Synergy City should be an economically self-sustaining enterprise.

Providing adequate fresh water to our Nation is becoming increasingly more difficult as population and technology expand and this problem is faced by other nations, as well. It is anticipated that the future may bring wars over water rights (Ref. 7). The technology of Synergy City, once developed, can be exported.

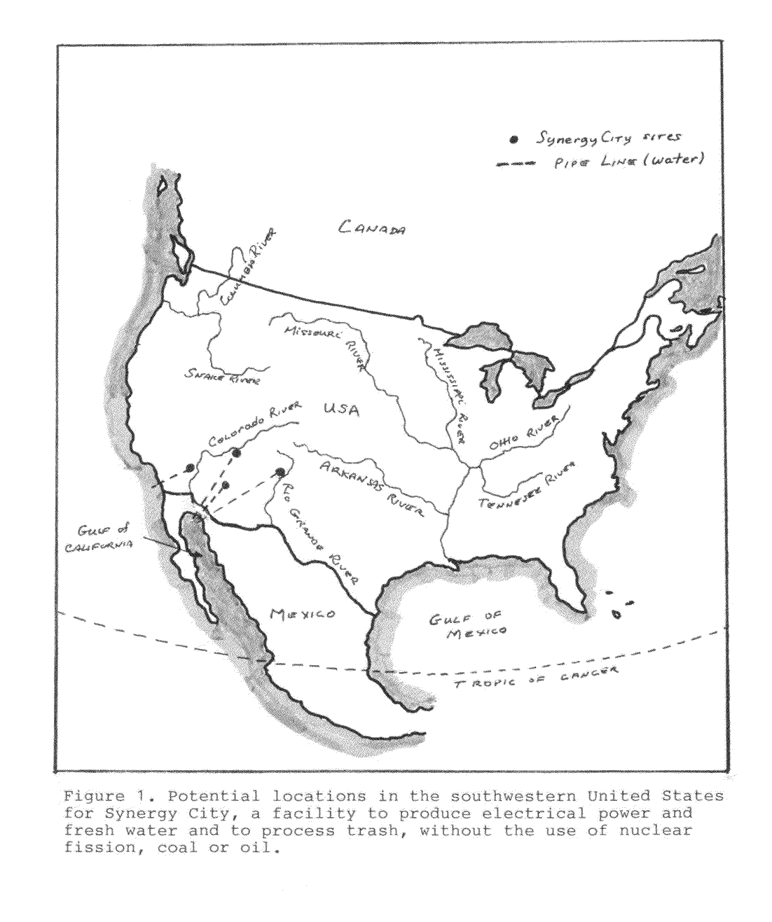

The once mighty Colorado and Rio Grande Rivers are now only trickles at their mouths due to everuse and the aquafiers beneath them are being rapidly depleted (Ref. 7). Replenishing these rivers would be a major economic and sociological benefit to the communities served by them and to our Nation. The Mexican government would likely welcome cooperation with our government in constructing a desalination plant on the Gulf of California knowing that the flow at the mouth of the Colorado River would be enhanced (FIG. 1).

Solving three critical problems (providing electrical power to our nation in an environmentally safe manner, providing fresh water to arid regions, and properly disposing of trash) in a synergistic way can turn these activities, each of which is presently very costly and not being solved in a satisfactory way, into an enterprise which is both economically and sociologically profitable.

Synergy City can be a source of employment opportunities for workers of all levels of academic backgrounds, talents and skills. A prototype facility can be developed rather quickly from which problems can be identified and lessons learned as the planning and construction preliminaries are underway for a much larger facility. Such cities can become man-made oases in areas of our country which are presently largely uninhabitable and not productive, while enhancing the environment in which they are located.

### BRIEF SUMMARY OF THE INVENTION

This invention creates a facility to be located in the arid southwestern region of the United States, which can be known as Synergy City, with five primary functions:

(1) To produce electrical power for our nation from energy sources other than nuclear fission, coal or oil;

(2) To process refuse from our cities by using it as fuel in turbine-generator plants to produce electrical power;

(3) To produce fresh water to use in the power plant and the city, and/to replenish rivers and aquafiers now being depleted in that region;

(4) To make effective use of the residue from the refuse-combustion and desalination processes;

(5) To provide a laboratory for basic and applied research into methods which can satisfy the immediate and long term energy needs of our country and to disseminate that knowledge throughout our nation and others, as appropriate.

Synergy City is to be comprised of engineers, scientists, technicians and their families, and others as necessary to support a viable American city in the state in which it is located.

The energy sources are to include solar, geothermal, wind, biomass, refuse and others which may be developed at Synergy City and elsewhere. Nuclear fission, coal and oil are specifically excluded as energy sources because of environmental and political concerns. All emissions are to meet or exceed clean-air and water standards.

Synergy City is to be planned prior to initial construction to satisfy the æsthetic values of its citizens with respect to schools, parks, churches, the arts and recreational facilities, as well as to fulfill its scientific and engineering objectives. It is to be a desirable place in which to raise a family and to contribute to the future of our country and mankind.

### DESCRIPTION OF THE INVENTION

A primary objective of Synergy City is to provide a working community of engineers, scientists, technicians and their families, with supporting personnel, to operate a facility devoted to providing a significant source of electrical power and fresh water to the United States, and to process trash from communities and cities in a beneficial and responsible manner.

The first Synergy City is to be considered as a prototype facility for learning about the practical problems associated with designing, constructing and operating such a facility.

The location of Synergy Cities should be away from areas prone to tornados, major earthquakes, and hurricanes (FIG. 1).

An estimate of electrical power distribution from Synergy City is presented in Table II:

TABLE II
Estimate of Electrical Power Distribution from Synergy City

| | |
|---|---|
| Solar photovoltaic | 25% |
| Solar thermal | 25 |
| Trash | 25 |
| Wind | 15 |
| Geothermal, biomass, etc. | 10 |
| | 100 |

A target total electrical power for the prototype is 1000 MW, out of which 50% may be required for its research, facility and community operations.

An objective of Synergy City is that all discharges, including heat, are to be used in a way beneficial to the local or national community. Salt from desalination facilities, which can be located at the sea water sources, can be stored in a desert location until a use is found for it. Power to operate the desalination facilities and to pump water from the coast to the city can be provided in part by local installations and in part by Synergy City.

Patents have been issued for a variety of systems and devices for producing heat and electrical power from the sun's energy (U.S. Pat. No. 7,836,695B2, U.S. Pat. No. 7,834,303B2, U.S. Pat. No. 7,825,327B2, U.S. Pat. No. 7,735,323B2), wind (U.S. Pat. No. 7,777,363B2, U.S. Pat. No. 7,735,325B2), geothermal sources (U.S. Pat. No. 7,753,122B2), and biomass systems (U.S. Pat. No. 7,744,671,B1, U.S. Pat. No. 7,789,026B2). However, no patents have apparently been awarded to integrate a variety of such sources into a synergistic, community-operated facility. Additionally, new developments in desalinating sea water may lead to more efficient systems in that area. (U.S. Pat. No. 7,832,714B2, U.S. Pat. No. 7,744,760B2). It is a purpose of Synergy City to provide an efficient and economical facility for evaluating the effectiveness of such developments in a practical environment.

Ash from combustion products is to be converted into building materials or other useful products and made commercially available. It is to be noted that Alkali Activated Cement (AAC) has recently been developed from iron slag, limestone, soda ash and NaOH (Ref. 8).

Solar panels are to be placed on elevated supporting structures to provide shade for parking lots, parks, lakes and other facilities, such as is being done in California in which a 2MW installation of solar photovoltaic panels provides shade for a parking lot (Ref. 9).

Cooperation with Mexican government officials will be required to operate a desalination plant in the Gulf of California. However, this should not pose a major problem since Mexico will benefit from enhanced flow of the Colorado River.

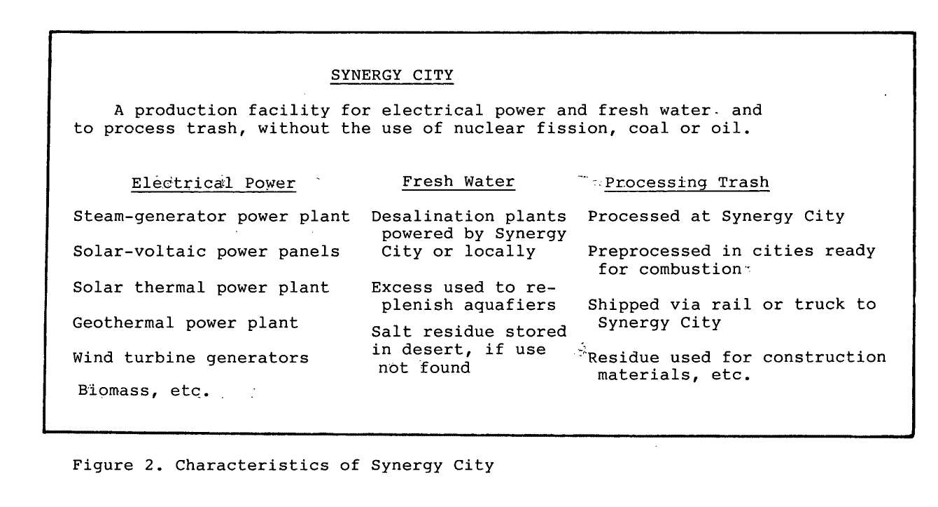

A summary of the characteristics of Synergy City is presented in FIG. 2.

Operation of the thermodynaic turbine-generator cycle shown in FIG. 3 differs from that of conventional plants in that a variety of heat sources is used to produce steam in the steam generator. This may require multiple generators, which can be run in series or parallel, as conditions dictate. For example, solar energy is obviously not available at night, therefore, refuse-burning, geothermal heat, methane combustion from biomass production, and possibly other sources not yet developed, would pick up the load. The wind turbines would run continuously, according to wind conditions.

The thermal cyle of FIG. 3 requires a heat sink in which to discharge rejected heat. Typically such sinks are rivers, lakes, spray ponds, or cooling towers. For Synergy City, a large man-made lake is conceived in which fresh water flows in from desalination plants processing sea water from the coast of California or the Gulf of California. Such desalination plants may be located at the sources using power produced locally or from Synergy City.

Fresh water used to cool the thermal systems in Synergy City flows into the lake and water at a slightly elevated temperature flows out of the lake into rivers and streams (Colorado and/or Rio Grande Rivers) and into the acquifier, which is now being depleted at an alarming rate.

This lake can be used for recreational purposes and is to be shielded from the desert sun by solar panels and collectors. (It is to be noted that a pool covering twenty acres extending half a mile has been created in Chile. This lake is 115 feet deep with a capacity of 66 million gallons (Ref. 7).)

An electrical distribution system is required to connect Synergy City's output to the Nation's grid.

A connection to the Nation's high speed rail system now under consideration is required for transporting refuse, people and supplies to the city. Highways and an airport are also required.

Although Synergy City is to be a production facility, cooperation with the Environmental Protection Agency, the National renewable Energy Laboratory, and the National Aeronautics and Space Administration (Ref. 6,9,10) is to occur in order to exchange information with these government agencies who are also involved in management of our Nation's energy resources.

1. That a production and research facility is conceived, which can be called Synergy City, to solve three major problems confronting the United States: the need for fresh water in arid regions of the southwestern United States to replenish rivers and aquifiers now being rapidly depleted; the need for electrical power produced from environmentally safe sources; and the need to safely dispose of trash from communities and cities;

2. That a production facility is conceived which provides electrical power, fresh water, and processes trash in an environmentally safe manner without contributing appreciably to global warming, or the dangers associated with the operaion of nuclear power plants or the accumulation of radioactive waste, or to the depletion of coal and oil reserves;

3. That a production facility is conceived which makes the United States safer from the consequences of terrorist attacks and reduces our vulnerability in time of war by reducing our dependency on nuclear power plants and foreign oil.
